(19) United States
(12) Patent Application Publication
(10) Pub. No.: US 2026/0243006 A1
(43) Pub. Date: Aug. 20, 2026

(54) CABINET ASSEMBLY HAVING A TOP COVER BRACKET FOR WASHING MACHINE APPLIANCE

(71) Applicant: Haier US Appliance Solutions, Inc., Wilmington, DE (US)

(72) Inventors: Rebretta Veasey, Louisville, KY (US); Christopher Gene Vowels, Cox's Creek, KY (US)

(21) Appl. No.: 19/056,897

(22) Filed: Feb. 19, 2025

(51) Int. Cl. D06F 39/12; D06F 23/02; D06F 37/26; F16B 5/02

(52) U.S. Cl. CPC D06F 39/12; D06F 23/02; D06F 37/268; F16B 5/02

(57) ABSTRACT

A system and method of assembling washing machine appliance including a panelized cabinet assembly. The washing machine appliance includes a cabinet assembly comprising a plurality of spring support brackets and a top cover bracket mechanically coupled to the plurality of spring support brackets. The top cover bracket includes a plurality of transverse locating tabs and a lateral locating tab to restrict movement of the top cover bracket.

### FIELD OF THE INVENTION

The present disclosure relates generally to laundry appliances, and more particularly to panelized cabinet assemblies for washing machine appliances.

### BACKGROUND OF THE INVENTION

Washing machine appliances generally include a cabinet that receives a tub for containing wash and rinse water. A wash basket is rotatably mounted within the tub. A drive assembly is coupled to the tub and configured to rotate the wash basket within the tub in order to cleanse articles within the wash basket. Upon completion of a wash cycle, a pump assembly can be used to rinse and drain soiled water to a draining system. Some washing machine appliances may also rotate the wash basket at a relatively high speed for a spin cycle to further drain or shed water from articles within the wash basket.

In general, the washing mashing cabinet assemblies are critical to the structural integrity of the washing machine appliance. These washing machine cabinet assemblies typically consist of either a u-shaped wrapper or multi-panel construction. A u-shaped wrapper includes a singular piece of the cabinet including a rear panel and two side panels, while a multi-panel construction includes individual and separate panels for the rear and side panels. Both the u-shaped wrapper and multi-panel construction require various support brackets to provide further structural reinforcement.

To ensure the structural integrity and quality of the washing machine appliance, the standard materials, designs, and methods of manufacture are often costly. Accordingly, improved cabinet assemblies and associated methods for obtaining improved cabinet assemblies would be useful. More specifically, improved cabinet assemblies and associated methods that can minimize parts and reduce labor costs while maintaining structural integrity would be particularly beneficial.

### BRIEF DESCRIPTION OF THE INVENTION

Aspects and advantages of the invention will be set forth in part in the following description, or may be obvious from the description, or may be learned through practice of the invention.

In one exemplary embodiment, washing machine appliance is provided. The washing machine appliance defining a mutually orthogonal vertical direction, lateral direction, and transverse direction includes a cabinet assembly defining a cabinet aperture, the cabinet assembly includes a plurality of spring support brackets permanently fastened to a top of a rear panel and a top of a plurality of side panels, and a top cover bracket mechanically coupled to a top of the plurality of spring support brackets, the top cover bracket including a plurality of transverse locating tabs located on each of a plurality of ends of the top cover bracket, and a lateral locating tab located on an end of the top cover bracket, and a wash tub suspended within the cabinet assembly by a suspension assembly.

In another exemplary embodiment, a method for assembling a washing machine appliance is provided. The washing machine appliance includes a cabinet assembly defining a cabinet aperture, the cabinet assembly comprising a top cover bracket mechanically coupled to a top of the plurality of spring support brackets, the top cover bracket comprising a plurality of transverse locating tabs located on each of a plurality of ends of the top cover bracket, and a lateral locating tab located on an end of the top cover bracket, a plurality of spring support brackets, the spring support brackets comprising a plurality of mating slots configured to receive the plurality of transverse locating tabs and the lateral locating tab permanently fastened to a top of a rear panel and a top of a plurality of side panels, and a wash tub suspended within the cabinet assembly by a suspension assembly. The method includes selecting a top cover bracket, placing the top cover bracket on top of the cabinet assembly, positioning the top cover bracket such that the plurality of transverse locating tabs are received in the plurality of mating slots in a plurality of tops of the plurality of spring support brackets to restrict top cover bracket translation in the transverse direction, and positioning the top cover bracket such that the lateral locating tab is received in one of the plurality of mating slots in the plurality of tops of the plurality of spring support brackets to restrict top cover bracket translation in the lateral direction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of an example washing machine appliance in accordance with one example embodiment of the present disclosure.

FIG. 2 provides a side cross-sectional view of the example washing machine appliance of FIG. 1 according to an example embodiment of the present subject matter.

FIG. 3 is a perspective view of an example cabinet assembly in accordance with one example embodiment of the present disclosure.

FIG. 4 is an exploded perspective view of the example cabinet assembly of FIG. 3 according to an example embodiment of the present subject matter.

FIG. 5 is a top perspective view of an example top cover bracket in accordance with one example embodiment of the present disclosure.

FIG. 6 is a partial top view of the example top cover bracket of FIG. 6 according to an example embodiment of the present subject matter.

FIG. 7 is a side cross-sectional view of the example top cover bracket of FIG. 6 coupled to a cabinet assembly according to an example embodiment of the present subject matter.

FIG. 8 is a perspective view of an end the example top cover bracket of FIG. 6 according to an example embodiment of the present subject matter.

FIG. 9 is a perspective view of an example front control bracket in accordance with one example embodiment of the present disclosure.

FIG. 10 is a partial cross-sectional perspective view of the example front control bracket of FIG. 9 coupled to a spring support bracket and side panel according to an example embodiment of the present subject matter.

FIG. 11 is a side cross-sectional perspective view of the example front control bracket of FIG. 9 coupled to an example spring support bracket and an example side panel according to an example embodiment of the present subject matter.

FIG. 12 is a perspective view of an alternative lanced locating tab design for the example front control bracket of FIG. 9 according to an example embodiment of the present subject matter.

FIG. 13 is a side perspective view of a first alternative vertical locating tab design for the example front control bracket of FIG. 9 according to an example embodiment of the present subject matter.

FIG. 14 is a side perspective view of a second alternative vertical locating tab design for the example front control bracket of FIG. 9 according to an example embodiment of the present subject matter.

FIG. 15 is a partial perspective view of the example cabinet assembly of FIG. 3 with an expanded view of an example spring support bracket according to an example embodiment of the present subject matter.

FIG. 16 is a front perspective view of an example spring support bracket in accordance with one example embodiment of the present disclosure.

FIG. 17 is a top perspective view of the example spring support bracket of FIG. 16 according to an example embodiment of the present subject matter.

FIG. 18 is a partial side perspective view of the example spring support bracket of FIG. 16 coupled to an example side panel according to an example embodiment of the present subject matter.

FIG. 19 is a perspective view of an example oversized spring aperture on the exemplary spring support bracket of FIG. 16 coupled to a side panel according to an example embodiment of the present subject matter.

FIG. 20 is a perspective view of an example plurality of spring apertures on the exemplary spring support bracket of FIG. 16 coupled to a side panel according to an example embodiment of the present subject matter.

FIG. 21 illustrates a method of assembling a washing machine appliance in accordance with one embodiment of the present disclosure.

Repeat use of reference characters in the present specification and drawings is intended to represent the same or analogous features or elements of the present invention.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and may not be intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). The term “at least one of” in the context of, e.g., “at least one of A, B, and C” refers to only A, only B, only C, or any combination of A, B, and C. As used herein, the terms “coupled,” “fixed,” “attached to,” and the like refer to both direct coupling, fixing, or attaching, as well as indirect coupling, fixing, or attaching through one or more intermediate components or features, unless otherwise specified herein. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

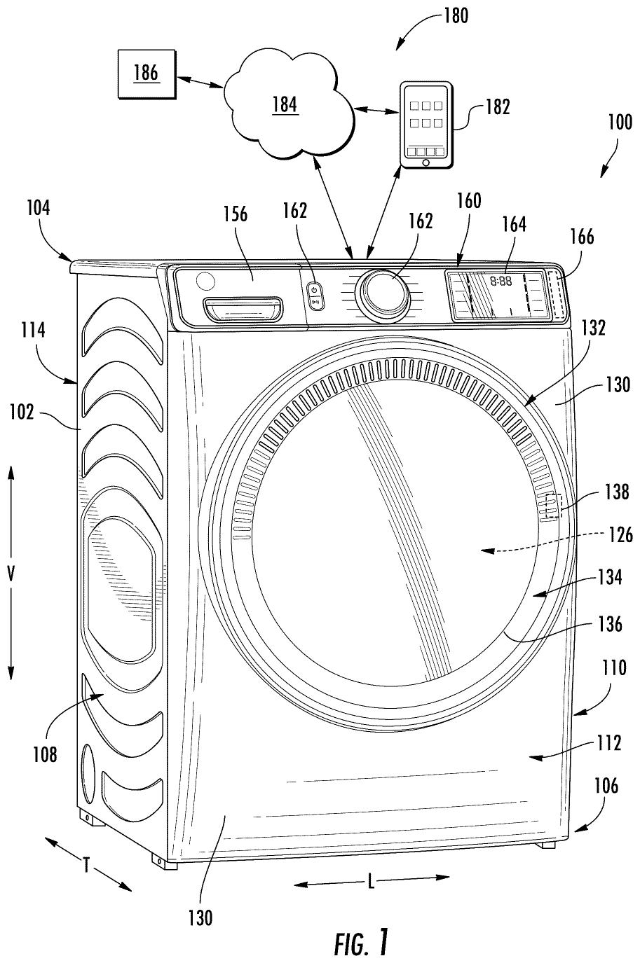

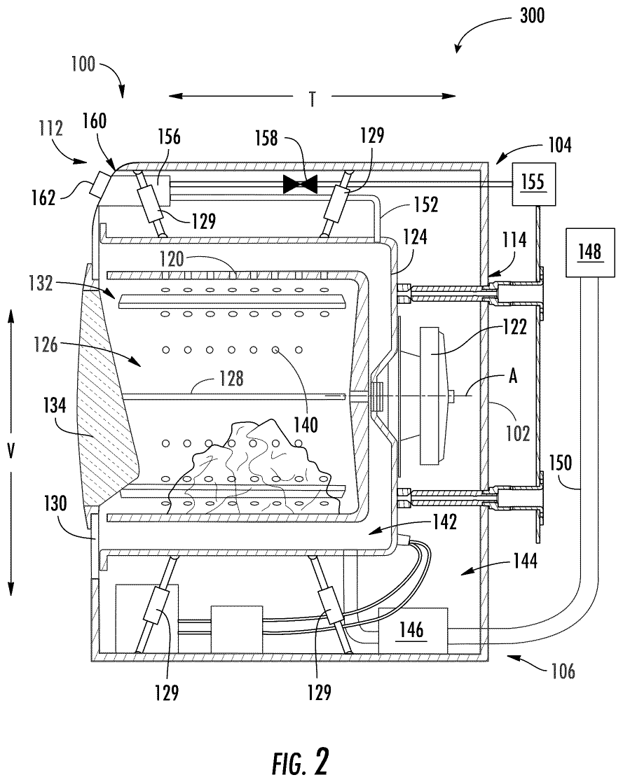

As explained herein, aspects of the present subject matter are generally directed to a laundry appliance including a washing machine appliance and/or a dryer appliance. Referring now to the figures, an exemplary laundry appliance that may be used to implement aspects of the present subject matter will be described. Specifically, FIG. 1 is a perspective view of an exemplary horizontal axis washing machine appliance 100 and FIG. 2 is a side cross-sectional view of washing machine appliance 100. As illustrated, washing machine appliance 100 generally defines a vertical direction V, a lateral direction L, and a transverse direction T, each of which is mutually perpendicular, such that an orthogonal coordinate system is generally defined.

According to exemplary embodiments, washing machine appliance 100 includes a cabinet 102 that defines a cabinet aperture and is generally configured for containing and/or supporting various components of washing machine appliance 100 and which may also define one or more internal chambers or compartments of washing machine appliance 100. In this regard, as used herein, the terms “cabinet,” “housing,” and the like are generally intended to refer to an outer frame or support structure for washing machine appliance 100, e.g., including any suitable number, type, and configuration of support structures formed from any suitable materials, such as a system of elongated support members, a plurality of interconnected panels (including a u-shaped wrapper and multi-panel constructions), or some combination thereof. It should be appreciated that cabinet 102 does not necessarily require an enclosure and may simply include open structure supporting various elements of washing machine appliance 100. By contrast, cabinet 102 may enclose some or all portions of an interior of cabinet 102. It should be appreciated that cabinet 102 may have any suitable size, shape, and configuration while remaining within the scope of the present subject matter.

As illustrated, cabinet 102 generally extends between a top panel 104 and a bottom panel 106 along the vertical direction V, between a first side panel 108 (e.g., the left side when viewed from the front as in FIG. 1) and a second side panel 110 (e.g., the right side when viewed from the front as in FIG. 1) along the lateral direction L, and between a front 112 and a rear panel 114 along the transverse direction T. In general, terms such as “left,” “right,” “front,” “rear,” “top,” or “bottom” are used with reference to the perspective of a user accessing washing machine appliance 100.

Referring to FIG. 2, a wash basket 120 is rotatably mounted within cabinet 102 such that it is rotatable about an axis of rotation A. A motor 122, e.g., such as a pancake motor, is in mechanical communication with wash basket 120 to selectively rotate wash basket 120 (e.g., during an agitation or a rinse cycle of washing machine appliance 100). Wash basket 120 is received within a wash tub 124 and defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. Indeed, for simplicity of discussion, these terms may all be used interchangeably herein without limiting the present subject matter to any particular “wash fluid.”

Wash basket 120 may define one or more agitator features that extend into wash chamber 126 to assist in agitation and cleaning articles disposed within wash chamber 126 during operation of washing machine appliance 100. For example, as illustrated in FIG. 2, a plurality of ribs 128 extends from basket 120 into wash chamber 126. In this manner, for example, ribs 128 may lift articles disposed in wash basket 120 during rotation of wash basket 120.

According to exemplary embodiments, wash tub 124 may be generally suspended within cabinet 102 by one or more suspension assemblies 129, e.g., as shown for example in FIG. 2. In this regard, wash tub 124, wash basket 120, motor 122, and other components of washing machine appliance 100 may be referred to generally herein as the subwasher. In order to reduce the transmission of vibrations and other forces from the subwasher to the cabinet 102 during operation of washing machine appliance 100, wash tub 124 may be generally isolated from cabinet 102 by suspension assemblies 129. This may be desirable to prevent undesirable noise, vibrations, “walking” of the appliance, etc. It should be appreciated that suspension assemblies 129 may generally include any suitable number and combination of springs, dampers, or other energy absorbing mechanisms to reduce the transmission of forces between the subwasher and cabinet 102. Although exemplary suspension assemblies 129 are illustrated herein, it should be appreciated that the number, type, and configuration of suspension assemblies 129 may vary while remaining within the scope of the present subject matter.

Referring generally to FIGS. 1 and 2, cabinet 102 also includes a front panel 130 which defines an opening 132 that permits user access to wash basket 120 of wash tub 124. More specifically, washing machine appliance 100 includes a door 134 that is positioned over opening 132 and is rotatably mounted to front panel 130. In this manner, door 134 permits selective access to opening 132 by being movable between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 100. Door 134 also includes a handle (not shown) that, e.g., a user may pull when opening and closing door 134. Further, although door 134 is illustrated as mounted to front panel 130, it should be appreciated that door 134 may be mounted to another side of cabinet 102 or any other suitable support according to alternative embodiments. Washing machine appliance 100 may further include a latch assembly 138 (see FIG. 1) that is mounted to cabinet 102 and/or door 134 for selectively locking door 134 in the closed position and/or confirming that the door is in the closed position. Latch assembly 138 may be desirable, for example, to ensure only secured access to wash chamber 126 or to otherwise ensure and verify that door 134 is closed during certain operating cycles or events.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 100. For example, during operation of washing machine appliance 100, wash fluid may be urged by gravity from basket 120 to sump 142 through plurality of perforations 140.

A drain pump assembly 144 is located beneath wash tub 124 and is in fluid communication with sump 142 for periodically discharging soiled wash fluid from washing machine appliance 100. Drain pump assembly 144 may generally include a drain pump 146 which is in fluid communication with sump 142 and with an external drain 148 through a drain hose 150. During a drain cycle, drain pump 146 urges a flow of wash fluid from sump 142, through drain hose 150, and to external drain 148. More specifically, drain pump 146 includes a motor (not shown) which is energized during a drain cycle such that drain pump 146 draws wash fluid from sump 142 and urges it through drain hose 150 to external drain 148.

Washing machine appliance 100 may further include a wash fluid dispenser that is generally configured for dispensing a flow of water, wash fluid, etc. into wash tub 124. For example, a spout 152 is configured for directing a flow of fluid into wash tub 124. For example, spout 152 may be in fluid communication with a water supply 154 (FIG. 2) in order to direct fluid (e.g., clean water or wash fluid) into wash tub 124. Spout 152 may also be in fluid communication with the sump 142. For example, pump assembly 144 may direct wash fluid disposed in sump 142 to spout 152 in order to circulate wash fluid in wash tub 124.

As illustrated in FIG. 2, a detergent drawer 156 is slidably mounted within front panel 130. Detergent drawer 156 receives a wash additive (e.g., detergent, fabric softener, bleach, or any other suitable liquid or powder) and directs the fluid additive to wash tub 124 during operation of washing machine appliance 100. According to the illustrated embodiment, detergent drawer 156 may also be fluidly coupled to spout 152 to facilitate the complete and accurate dispensing of wash additive. It should be appreciated that according to alternative embodiments, these wash additives could be dispensed automatically via a bulk dispensing unit (not shown). Other systems and methods for providing wash additives are possible and within the scope of the present subject matter.

In addition, a water supply valve 158 may provide a flow of water from a water supply source (such as a municipal water supply 154) into detergent dispenser 156 and into wash tub 124. In this manner, water supply valve 158 may generally be operable to supply water into detergent dispenser 156 to generate a wash fluid, e.g., for use in a wash cycle, or a flow of fresh water, e.g., for a rinse cycle. It should be appreciated that water supply valve 158 may be positioned at any other suitable location within cabinet 102. In addition, although water supply valve 158 is described herein as regulating the flow of “wash fluid,” it should be appreciated that this term includes, water, detergent, other additives, or some mixture thereof.

During operation of washing machine appliance 100, laundry items are loaded into wash basket 120 through opening 132, and washing operation is initiated through operator manipulation of one or more input selectors or using a remote device (see below). Wash tub 124 is filled with water, detergent, and/or other fluid additives, e.g., via spout 152 and/or detergent drawer 156. One or more valves (e.g., water supply valve 158) can be controlled by washing machine appliance 100 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a final spin cycle, basket 120 is rotated at relatively high speeds and drain assembly 144 may discharge wash fluid from sump 142. After articles disposed in wash basket 120 are cleaned, washed, and/or rinsed, the user can remove the articles from wash basket 120, e.g., by opening door 134 and reaching into wash basket 120 through opening 132.

Referring again to FIG. 1, washing machine appliance 100 may include a control panel 160 that may represent a general-purpose Input/Output (“GPIO”) device or functional block for washing machine appliance 100. In some embodiments, control panel 160 may include or be in operative communication with one or more user input devices 162, such as one or more of a variety of digital, analog, electrical, mechanical, or electro-mechanical input devices including rotary dials, control knobs, push buttons, toggle switches, selector switches, and touch pads. Additionally, washing machine appliance 100 may include a display 164, such as a digital or analog display device generally configured to provide visual feedback regarding the operation of washing machine appliance 100. For example, display 164 may be provided on control panel 160 and may include one or more status lights, screens, or visible indicators. According to exemplary embodiments, user input devices 162 and display 164 may be integrated into a single device, e.g., including one or more of a touchscreen interface, a capacitive touch panel, a liquid crystal display (LCD), a plasma display panel (PDP), a cathode ray tube (CRT) display, or other informational or interactive displays.

Washing machine appliance 100 may further include or be in operative communication with a processing device or a controller 166 that may be generally configured to facilitate appliance operation. In this regard, control panel 160, user input devices 162, and display 164 may be in communication with controller 166 such that controller 166 may receive control inputs from user input devices 162, may display information using display 164, and may otherwise regulate operation of washing machine appliance 100. For example, signals generated by controller 166 may operate washing machine appliance 100, including any or all system components, subsystems, or interconnected devices, in response to the position of user input devices 162 and other control commands. Control panel 160 and other components of washing machine appliance 100 may be in communication with controller 166 via, for example, one or more signal lines or shared communication busses. In this manner, Input/Output (“I/O”) signals may be routed between controller 166 and various operational components of washing machine appliance 100.

As used herein, the terms “processing device,” “computing device,” “controller,” or the like may generally refer to any suitable processing device, such as a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, these “controllers” are not necessarily restricted to a single element but may include any suitable number, type, and configuration of processing devices integrated in any suitable manner to facilitate appliance operation. Alternatively, controller 166 may be constructed without using a microprocessor, e.g., using a combination of discrete analog and/or digital logic circuitry (such as switches, amplifiers, integrators, comparators, flip-flops, AND/OR gates, and the like) to perform control functionality instead of relying upon software.

Controller 166 may include, or be associated with, one or more memory elements or non-transitory computer-readable storage mediums, such as RAM, ROM, EEPROM, EPROM, flash memory devices, magnetic disks, or other suitable memory devices (including combinations thereof). These memory devices may be a separate component from the processor or may be included onboard within the processor. In addition, these memory devices can store information and/or data accessible by the one or more processors, including instructions that can be executed by the one or more processors. It should be appreciated that the instructions can be software written in any suitable programming language or can be implemented in hardware. Additionally, or alternatively, the instructions can be executed logically and/or virtually using separate threads on one or more processors.

For example, controller 166 may be operable to execute programming instructions or micro-control code associated with an operating cycle of washing machine appliance 100. In this regard, the instructions may be software or any set of instructions that when executed by the processing device, cause the processing device to perform operations, such as running one or more software applications, displaying a user interface, receiving user input, processing user input, etc. Moreover, it should be noted that controller 166 as disclosed herein is capable of and may be operable to perform any methods, method steps, or portions of methods of appliance operation. For example, in some embodiments, these methods may be embodied in programming instructions stored in the memory and executed by controller 166.

The memory devices may also store data that can be retrieved, manipulated, created, or stored by the one or more processors or portions of controller 166. The data can include, for instance, data to facilitate performance of methods described herein. The data can be stored locally (e.g., on controller 166) in one or more databases and/or may be split up so that the data is stored in multiple locations. In addition, or alternatively, the one or more database(s) can be connected to controller 166 through any suitable network(s), such as through a high bandwidth local area network (LAN) or wide area network (WAN). In this regard, for example, controller 166 may further include a communication module or interface that may be used to communicate with one or more other component(s) of washing machine appliance 100, controller 166, an external appliance controller, or any other suitable device, e.g., via any suitable communication lines or network(s) and using any suitable communication protocol. The communication interface can include any suitable components for interfacing with one or more network(s), including for example, transmitters, receivers, ports, controllers, antennas, or other suitable components.

Referring again to FIG. 1, a schematic diagram of an external communication system 180 will be described according to an exemplary embodiment of the present subject matter. In general, external communication system 180 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 180 may be used to transfer data or other information to improve performance of one or more external devices or appliances and/or improve user interaction with such devices.

For example, external communication system 180 permits controller 166 of washing machine appliance 100 to communicate with a separate device external to washing machine appliance 100, referred to generally herein as an external device 182. As described in more detail below, these communications may be facilitated using a wired or wireless connection, such as via a network 184. In general, external device 182 may be any suitable device separate from washing machine appliance 100 that is configured to provide and/or receive communications, information, data, or commands from a user. In this regard, external device 182 may be, for example, a personal phone, a smartphone, a tablet, a laptop or personal computer, a wearable device, a smart home system, or another mobile or remote device.

In addition, a remote server 186 may be in communication with washing machine appliance 100 and/or external device 182 through network 184. In this regard, for example, remote server 186 may be a cloud-based server 186, and is thus located at a distant location, such as in a separate state, country, etc. According to an exemplary embodiment, external device 182 may communicate with a remote server 186 over network 184, such as the Internet, to transmit/receive data or information, provide user inputs, receive user notifications or instructions, interact with or control washing machine appliance 100, etc. In addition, external device 182 and remote server 186 may communicate with washing machine appliance 100 to communicate similar information.

In general, communication between washing machine appliance 100, external device 182, remote server 186, and/or other user devices or appliances may be carried using any type of wired or wireless connection and using any suitable type of communication network, non-limiting examples of which are provided below. For example, external device 182 may be in direct or indirect communication with washing machine appliance 100 through any suitable wired or wireless communication connections or interfaces, such as network 184. For example, network 184 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 180 is described herein according to an exemplary embodiment of the present subject matter. However, it should be appreciated that the exemplary functions and configurations of external communication system 180 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

While described in the context of a specific embodiment of horizontal axis washing machine appliance 100, using the teachings disclosed herein it will be understood that horizontal axis washing machine appliance 100 is provided by way of example only. Other washing machine appliances having different configurations, different appearances, and/or different features may also be utilized with the present subject matter as well, e.g., vertical axis washing machine appliances.

Also present in the exemplary washing machine appliance 100 is a cabinet assembly 300, which is described in detail below. In one example embodiment, cabinet assembly 300 allows for use of common parts and includes a reinforced panelized assembly. Additionally, cabinet assembly 300 allows for reduced use of mechanical fasteners, 330, e.g., screws, clamps, brackets, etc., as will be explained in greater detail below.

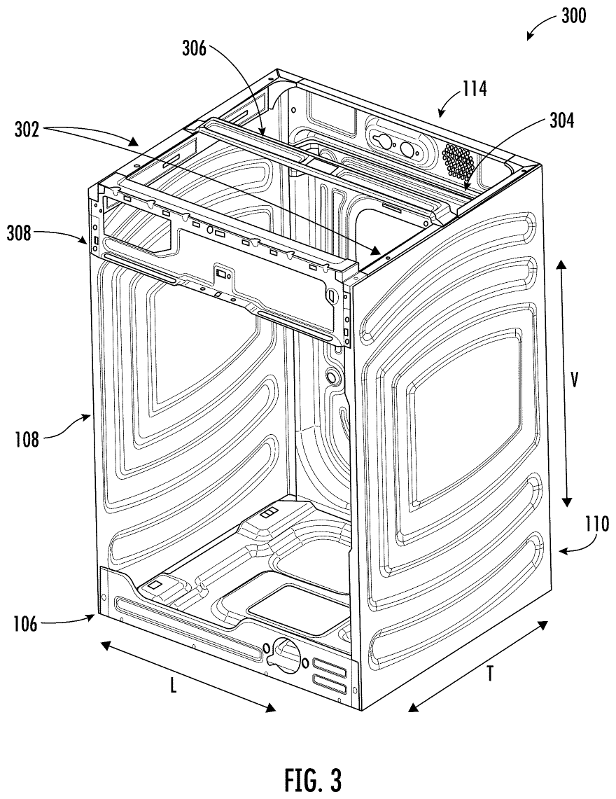

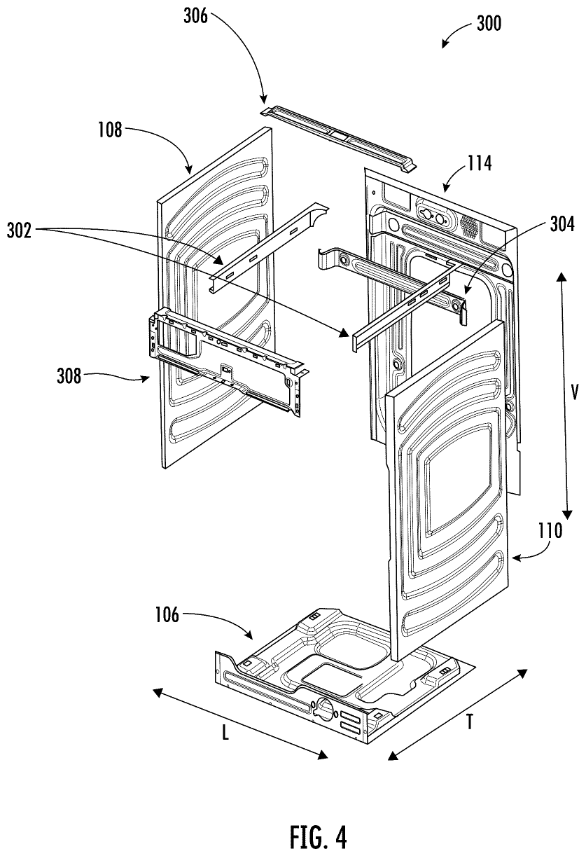

As best illustrated in FIGS. 3 and 4, in order to facilitate maintaining structural integrity of washing machine appliance 100 while reducing the number of different parts used and number of total parts used, cabinet assembly 300 is utilized. The cabinet assembly 300 allows for a reduced use of mechanical fasteners 330 such as screws, bolts, etc. by having panels and brackets reciprocally permanently fastened via a permanent fastener 310.

As used herein “permanently fastened” and/or “permanent fastener” 310 refers to a mechanical fastening technique that uses a clinching technique to create strong, permanent connections between two or more components having a material that is moldable or manipulatable to create a custom linking shape. These materials include metal (e.g., stainless steel, carbon steel, spring steel, etc.), plastic, polycarbonate, polypropylene, acrylic, timber, porcelain enamel, etc. These permanent connections involve utilizing the clinching technique which includes intentional reciprocal deformation of the material of the pieces to be fastened to create secure, permanent joints without the use of additional fasteners such as screws, bolts, etc. The clinching technique also involves the components to be joined together being precisely cut, cleaned and positioned in a clinching die assembly. The components to be joined together are firmly clamped in place, ensuring proper alignment and preventing unwanted movement by restricting all six degrees of freedom during the clinching operation. A specialized punch tool applies localized force to the clamped materials, causing the material to plastically deform and flow into the die cavity. As the punch presses into the components to be joined together, the material is drawn and extruded, forming a clinched joint.

In one example embodiment, as best illustrated in FIGS. 3 and 4, cabinet assembly 300, defines a cabinet aperture, and includes a rear panel 114 extending along a rear plane defined by the longitudinal direction and vertical direction and a plurality of side panels 108, 110 extending along a side plane defined by the transverse direction and vertical direction coupled to the rear panel 114. Additionally, cabinet assembly 300 includes a bottom panel 106 extending along a bottom plane defined by the transverse direction and longitudinal direction coupled to a bottom of the rear panel 114 and a bottom of the plurality of side panels 108, 110. Also, a plurality of spring support brackets 302 may be permanently fastened 310 to a top of the rear panel 114 and a top of the plurality of side panels 108, 110. In an example embodiment, the rear panel 114 is permanently fastened 310 to the plurality of side panels 108, 110. Furthermore, the bottom panel 106 is permanently fastened 310 to the rear panel 114 and the plurality of side panels 108, 110. In an alternative embodiment, the rear panel 114, plurality of side panels 108, 110, and bottom panel 106 are coupled together via a mechanical fastener 330 instead of being permanently fastened via a permanent fastener 310.

The cabinet assembly 300 may also include a front control bracket 308 mechanically coupled to the plurality of spring support brackets 302 and the front of the plurality of side panels 108, 110. In one example embodiment, the cabinet assembly 300 may also include a top cover bracket 306 oriented along the transverse direction mechanically coupled to the top of the rear panel 114 and a top of the front control bracket 308. This embodiment would be present in a vertical axis washing machine appliance. In an alternative embodiment, the cabinet assembly 300 may also include a top cover bracket 306 oriented along the lateral direction mechanically coupled to a top of the plurality of spring support brackets 302. This embodiment may also be mechanically coupled to the plurality of side panels 108, 110. This embodiment would be present in a horizontal axis washing machine appliance, as illustrated in FIGS. 3 and 4.

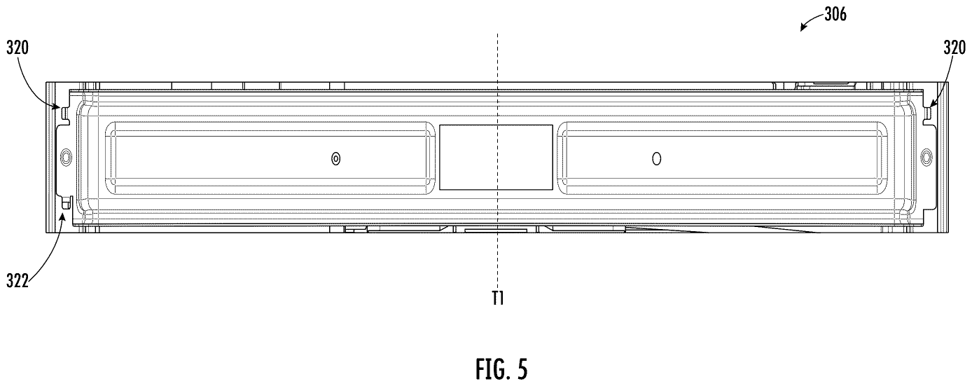

The cabinet assembly 300 may also include a top cover bracket 306 oriented along the lateral direction mechanically coupled to a top of the plurality of spring support brackets 302. In one example embodiment, the plurality of spring support brackets 302 are axially symmetrical about a transverse plane T1 (shown in FIG. 5). In another example embodiment, the plurality of spring support brackets are also permanently fastened 310 to a front of the plurality of side panels 108, 110. In an example embodiment, permanently fastened 310 is defined by a clinching technique, wherein the clinching technique includes clamping a plurality of components together at a joint location where the clinching will occur. In another example embodiment, the plurality of spring support brackets 302 are generally rectangular. Finally, a shipping bracket 304 may be included in a cabinet assembly 300 and be permanently fastened 310 to a front of the rear panel 114 for structural support, and may also be permanently fastened 310 to the plurality of side panels 108, 110.

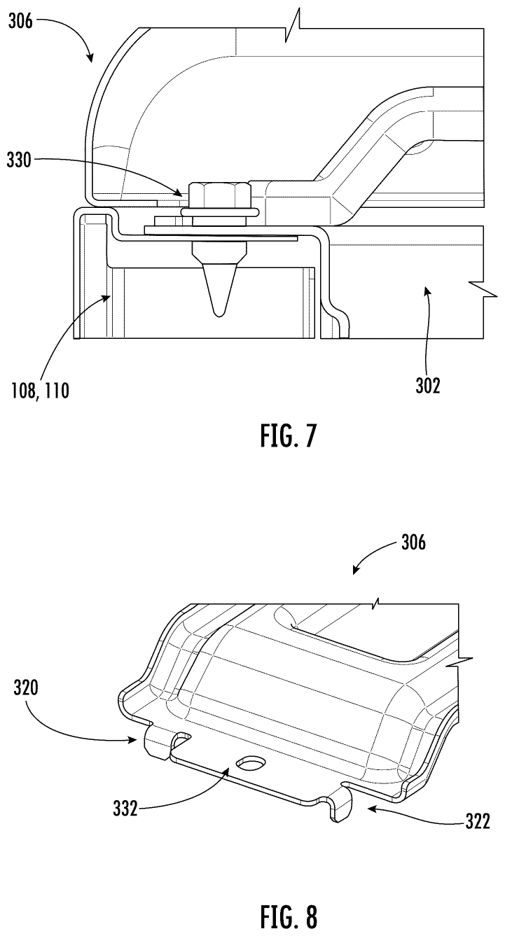

Referring now to FIGS. 5 through 8, an example embodiment of the cabinet assembly 300 is provided. Horizontal axis washing machine appliances, e.g. washing machine appliance 100, may employ a top cover bracket 306 to provide a mounting surface for foam pads, which isolate noise caused by top panel 104 vibration. These brackets may be installed either in the lateral direction or transverse direction in the cabinet assembly 300.

The cabinet assembly 300 may include a plurality of spring support brackets 302 permanently fastened 310 to a top of a rear panel 114 and a top of a plurality of side panels 108, 110, and a top cover bracket 306 mechanically coupled to a top of the plurality of spring support brackets 302. In this example embodiment, the top cover bracket 306 may include a plurality of transverse locating tabs 320 located on each of a plurality of ends of the top cover bracket 306, and a lateral locating tab 322 located on an end of the top cover bracket 306. This example cabinet assembly 300 may be included in washing machine appliance 100.

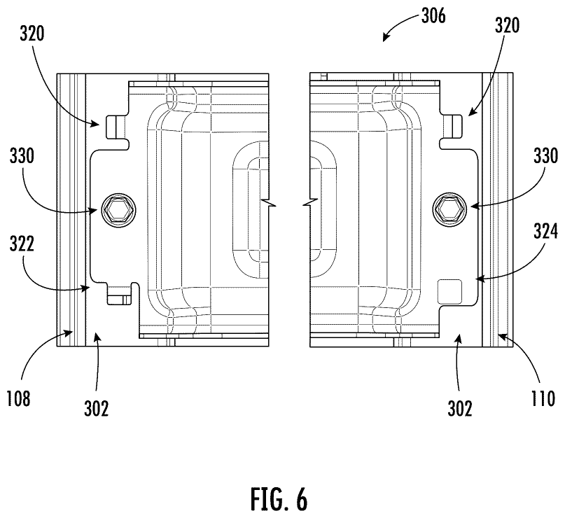

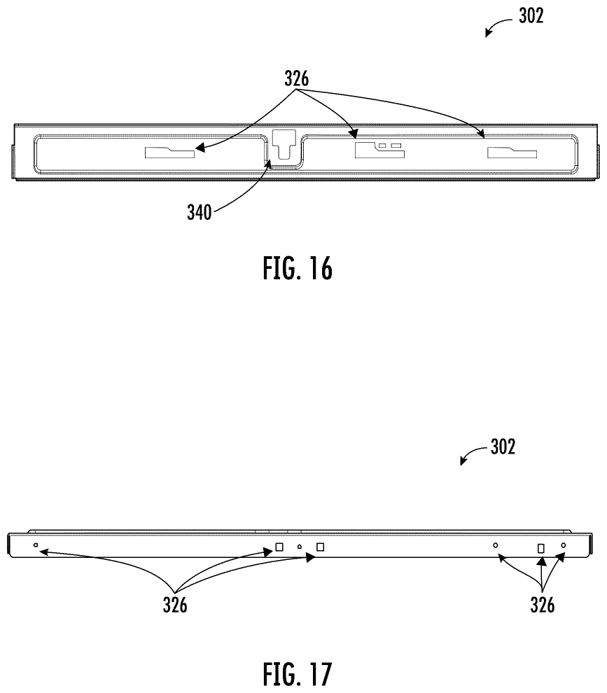

In this regard, the example cabinet assembly 300 may further include a rear panel 114, a plurality of side panels 108, 110 coupled to the rear panel 114, and a bottom panel 106 coupled to the rear panel 114 and plurality of side panels 108, 110. In another example embodiment, the top cover bracket 306 may be mechanically coupled to the top of the plurality of side panels 108, 110. Further, each of the tops of the plurality of side panels 108, 110 may include a plurality of mating slots 326 configured to receive the plurality of transverse locating tabs 320 and the lateral locating tab 322 located on the top cover bracket 306. Additionally, the tops of the plurality of spring support brackets 302 may include a plurality of mating slots 326 configured to receive a plurality of transverse locating tabs 320 and a lateral locating tab 322 located on the top cover bracket (FIG. 16). The plurality of transverse locating tabs 320 are received in the plurality of mating slots 326 to restrict top cover bracket 306 translation in the transverse direction. Also, the lateral locating tab 322 is received in one of the plurality of mating slots 326 to restrict top cover bracket 306 translation in the lateral direction. In an example embodiment, the plurality of mating slots 326 are configured to receive at least one of the plurality of transverse locating tabs 320 and a lateral locating tab 322 from the end of the top cover bracket 306. Additionally, the top cover bracket 306 may further include a mechanical fastener aperture 332 located below each of the plurality of transverse locating tabs 320 configured to receive a mechanical fastener 330. Further, an end of the top cover bracket 306 without a lateral locating tab 322 may further include a mating slot cover plate 324, as illustrated in FIG. 6.

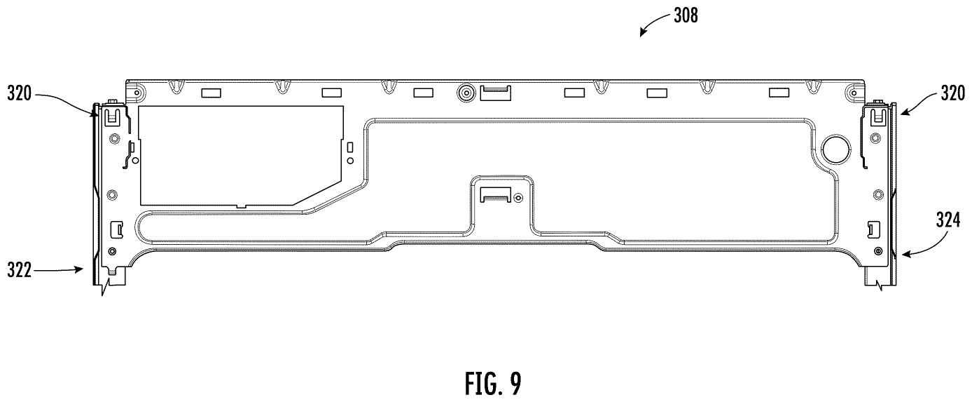

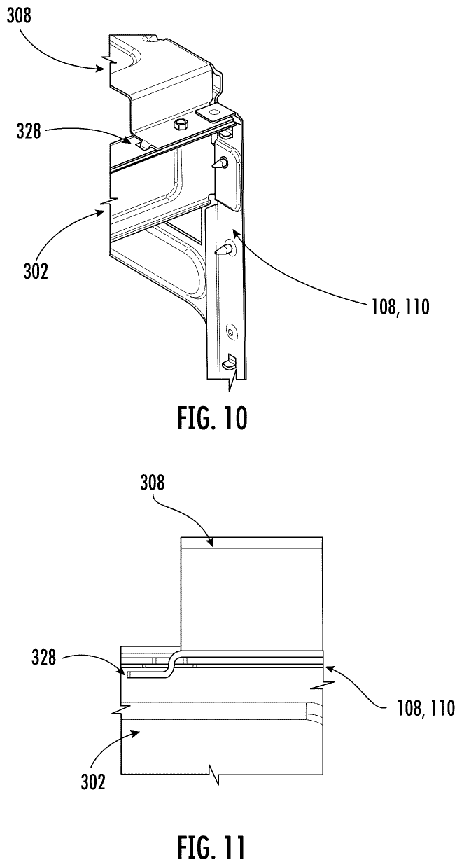

Referring now to FIG. 9-14, in another example embodiment, the cabinet assembly 300 further comprises a front control bracket 308 mechanically coupled to the front of the plurality of side panels 108, 110. As best illustrated in FIG. 9-11, in one example embodiment, the front control bracket 308 may include a plurality of transverse locating tabs 320 located on each of an end of a front of the front control bracket 308, and a lateral locating tab 322 located on an end of the front of the front control bracket 308. In one alternative example embodiment, the front control bracket 308 may further include a plurality of vertical locating tabs 328 located on each of an end of a top of the front control bracket 308. In another alternative embodiment, the lateral locating tab 322 may take the shape of a transverse locating tab 320 to prevent the front control bracket's 308 movement about the lateral direction. In addition to or alternatively, the lateral locating tab 322 may prevent the front control bracket's 308 rotation on the cabinet assembly 300. All of the locating tabs 320, 322, 328 are oriented to restrict front control bracket's 308 movement about all six degrees of freedom. Additionally or alternatively, the locating tabs 320, 322 are oriented to restrict the front control bracket's 308 movement about the lateral direction. Additionally or alternatively, the plurality of vertical locating tabs 328 are oriented to restrict the front control bracket's 308 movement about the vertical and/or transverse direction. Additionally, the front control bracket 308 may be placed in the cabinet assembly in an orientation, as illustrated by the example embodiment FIG. 9, where the lateral locating tab 322 is located on a left side panel 108, or the front control bracket 308 may be placed in the cabinet assembly in an orientation rotated 180 degrees from the example embodiment shown in FIG. 9, where the lateral locating tab 322 is located on the right side panel 110. In one example embodiment, front control bracket 308 may feature a mating cover plate 324, on an end of the front control bracket 308 that only features one of the plurality of transverse locating tabs 320.

In another example embodiment, the front control bracket 308 is mechanically coupled to a top of the plurality of side panels 108, 110. This embodiment may also have the cabinet assembly 300 include a plurality of spring support brackets 302 that are coupled to a top of the rear panel 114 and the top of the plurality of side panels 108, 110. This coupling may be via a mechanical fastener 330 or via permanent fastener 310. The mechanical fastener 330 of permanent fastener 310 coupling front control bracket 308 to the plurality of side panels 108, 110 may first go through the plurality of spring support brackets 302, as illustrated in FIG. 10, before the plurality of side panels 108, 110. The cabinet assembly 300 may further include a top cover bracket mechanically coupled to a top of the plurality of spring support brackets 302, wherein the top cover bracket 306 is symmetrical about a transverse plane. In one example embodiment, wherein the front control bracket 308 is mechanically coupled to a plurality of spring support brackets 302, as mentioned above. In another example embodiment, the cabinet assembly 300 may further include a top cover bracket 306 mechanically coupled to a top of the plurality of spring support brackets 302, wherein the top cover bracket 306 is symmetrical about a transverse plane.

In another example embodiment, each of the top of the plurality of side panels 108, 110 includes a plurality of mating slots 326 configured to receive a plurality of vertical locating tabs 328. Further, each of the front of the plurality of side panels 108, 110 includes a plurality of mating slots 326 configured to receive a plurality of transverse locating tabs 320 and a lateral locating tab 322 located on the front control bracket 308. The plurality of vertical locating tabs 328 are received in the plurality of mating slots 326 to restrict front control bracket 306 translation in the vertical direction. Additionally or alternatively, the plurality of transverse locating tabs 320 are received in the plurality of mating slots 326 to restrict front control bracket 306 translation in the transverse direction. Additionally or alternatively, the lateral locating tab 322 is received in one of the plurality of mating slots 326 to restrict front control bracket 308 translation in the lateral direction.

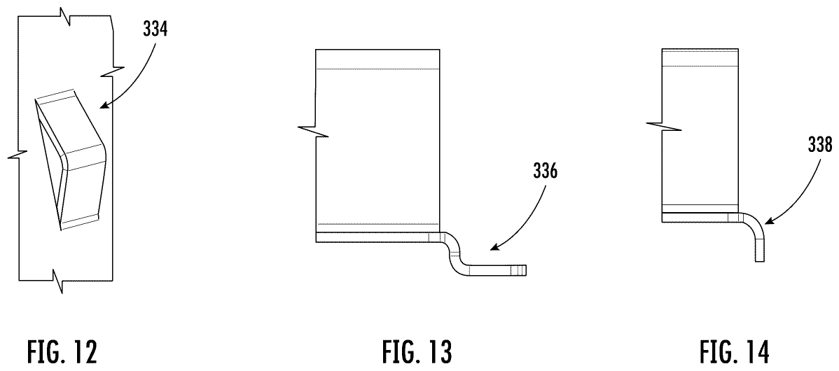

In an alternative embodiment, the plurality of transverse locating tabs 320 and the lateral locating tab 322 may take the shape of a lanced locating tab 334 of the front control bracket 308, as illustrated in FIG. 12. In another alternative embodiment, the plurality of vertical locating tabs 328 may take the shape of a first alternative locating tab 336, which extends downward before extending horizontally into the mating slot 326, as illustrated in FIG. 13. In another alternative embodiment, the plurality of vertical locating tabs 328 may take the shape of a second alternative locating tab 338, which curves before extending downward into the mating slot 326, as illustrated in FIG. 14.

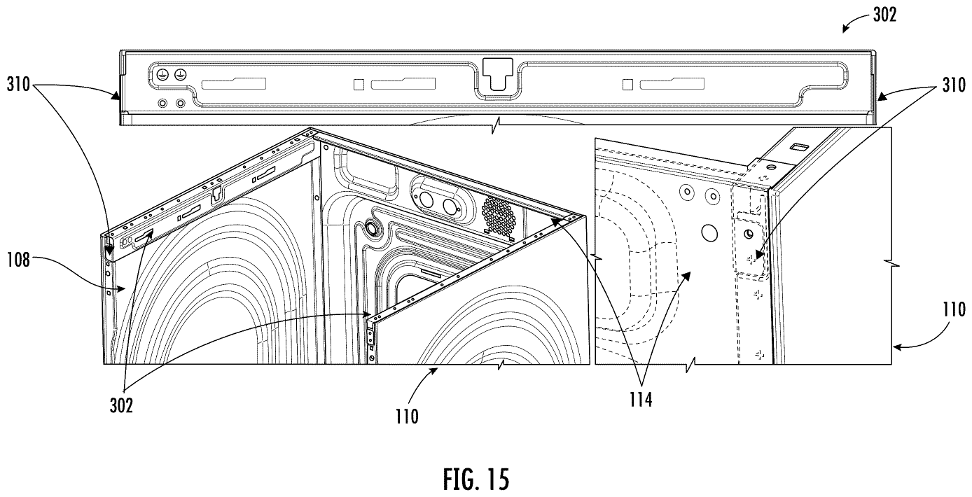

Referring now to FIG. 15-20, in another example embodiment, the cabinet assembly 300 further includes a plurality of spring support brackets 302 coupled to a top of the rear panel 114 and a top of the plurality of side panels 108, 110. Furthermore, the spring support brackets 302 may be coupled to a front of the plurality of side panels 108, 110 and a rear of the plurality of side panels 108, 110. This coupling may be a mechanically fastening 330 or permanent fastening 310. In one example embodiment, the plurality of spring support brackets 302 are symmetric about a transverse plane. For example, the plurality of spring support brackets 302, as illustrated in FIG. 15, may be identical or a mirror image thereof.

As best illustrated in FIG. 16-20, the plurality of spring support brackets 302 may include a single spring aperture 340 located on a side of the plurality of spring support brackets 302. This spring aperture 340 may be configured to receive a spring from the left side panel 108 or right side panel 110, regardless of which side of the plurality of spring support brackets 302 is facing the respective side panel 108, 110. The spring aperture 340 may be centered on the side of the plurality of spring support brackets 302 in one embodiment, or it may be strategically placed along the side of the plurality of spring support brackets 302 in another example embodiment.

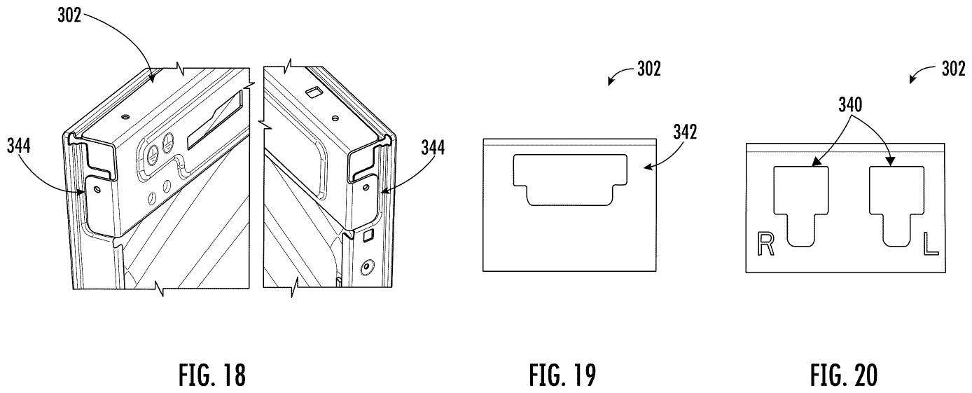

In another example embodiment and as illustrated in FIG. 18, the plurality of spring support brackets 302 have a plurality of ends that are configured to be received or recess into a cutout of the plurality of side panels 108, 110 configured for receiving the plurality of ends of the plurality of spring support brackets 302. This allows the plurality of sides of the plurality of spring support brackets 302 to sit flush with the exterior of a side of the plurality of side panels 108, 110, which allows for thin panel walls while maintaining structural integrity. In an alternative embodiment the plurality of side panels 108, 110 have a plurality of ends that are configured to be received or recess into a cutout of the plurality of spring support brackets 302 configured for receiving the plurality of ends of the plurality of side panels 108, 110. This embodiment allows the plurality of the sides of the plurality of side panels 108, 110 to sit flush with the exterior of a side of the plurality of spring support brackets 302.

In another example embodiment, the spring aperture 340 is an oversized spring aperture 342, as illustrated in FIG. 19. This oversized spring aperture 340 is positioned, centered or otherwise, along the side of the plurality of spring support brackets 302 to receive at least one spring, where each of the at least one spring fit into a separate end of the oversized spring aperture 342. The oversized aperture 342 allows the spring support bracket 302 to be placed on the cabinet assembly 100 with either the front of the spring support bracket 302 or the back of the spring support bracket 302 oriented adjacent to the plurality of side panels 108, 110. In practice, this makes the spring support bracket 302 reversible.

In an alternative example embodiment, the plurality of spring support brackets 302 comprise a plurality of spring apertures 340, as illustrated in FIG. 20. Each of these plurality of spring apertures 340 are configured to receive a spring. The plurality of spring apertures 340 may be evenly distributed on the side of the plurality of spring support brackets 302. The placement of these plurality of spring apertures 340 may allow the spring support bracket 302 to be placed on the cabinet assembly 100 with either the front of the spring support bracket 302 or the back of the spring support bracket 302 oriented adjacent to the plurality of side panels 108, 110.

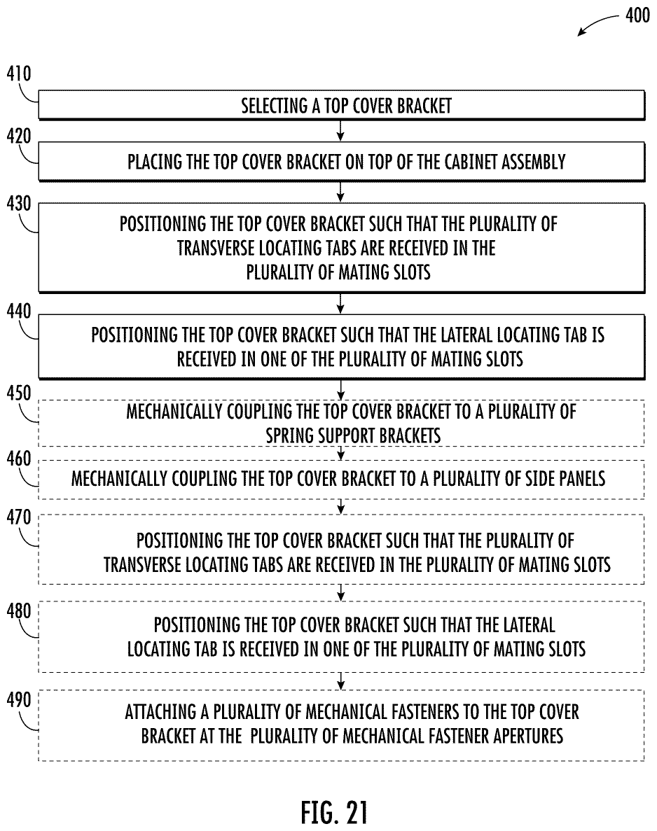

Referring now to FIG. 21, method 400 includes at 410, selecting a top cover bracket. As explained above, an example embodiment of the top cover bracket 306 is designed to be a part of an example cabinet assembly 300 for an example washing machine appliance 100. Selecting the example top cover bracket from an inventory pile, manufacturing line, or other staging area is a natural first step in adding it to the cabinet assembly 300.

Method 400 further includes, at 420, placing the top cover bracket on top of the cabinet assembly. As explained above, the orientation of the top cover bracket 306 may be where the lateral locating tab couples to the left side panel 108 or the right side panel 110. This flexibility reduces the requirements of exact staging and placement into the cabinet assembly 300.

Method 400 further includes, at 430, positioning the top cover bracket such that the plurality of transverse locating tabs are received in the plurality of mating slots in a plurality of tops of the plurality of spring support brackets to restrict top cover bracket translation in the transverse direction. As explained above, the plurality of transverse locating tabs 320 received in the plurality of mating slots on the plurality of spring support brackets 302 restrict top cover bracket 306 translation in the transverse direction. The same restriction of top cover bracket 306 translation in the transverse direction can be applied to the plurality of transverse locating tabs 320 received in the plurality of mating slots 326 on the plurality of side panels 108, 110.

Method 400 further includes, at 440, positioning the top cover bracket such that the lateral locating tab is received in one of the plurality of mating slots in the plurality of tops of the plurality of spring support brackets to restrict top cover bracket translation in the lateral direction. As explained above, the lateral locating tab 322 is received in one of the plurality of mating slots 326 in the plurality of tops of the plurality of spring support brackets 302 to restrict top cover bracket translation in the lateral direction. The same restriction of top cover bracket 306 translation in the lateral direction can be applied to the lateral locating tab 322 received in one of the plurality of mating slots 326 on the plurality of side panels 108, 110.

Method 400 may further include, at 450, mechanically coupling the top cover bracket to a top of a plurality of spring support brackets via a plurality of mechanical fasteners. As explained above, the top cover bracket 306 may include a mechanical fastener aperture 332 located below each of the plurality of transverse locating tabs 320 configured to receive a mechanical fastener 330.

Method 400 may further include, at 460, mechanically coupling the top cover bracket to the top of a plurality of side panels via a plurality of mechanical fasteners. As explained above, the mechanical fastener 330 may pass through the top cover bracket 306, then the plurality of spring support brackets 302, and then the plurality of side panels 108, 110.

Method 400 may further include, at 470, positioning the top cover bracket such that the plurality of transverse locating tabs are received in the plurality of mating slots in a plurality of tops of the plurality of side panels to restrict top cover bracket translation in the transverse direction. Similar to the mechanical fastener in step 460, the plurality of transverse locating tabs 320 may pass through the plurality of spring support brackets 302, and then into the plurality of side panels 108, 110.

Method 400 may further include, at 480, positioning the top cover bracket such that the lateral locating tab is received in one of the plurality of mating slots in the plurality of tops of the plurality of side panels to restrict top cover bracket translation in the lateral direction. Similar to the plurality of transverse locating tabs in step 460, the lateral locating tabs 322 may pass through the plurality of spring support brackets 302, and then into the plurality of side panels 108, 110.

Method 400 may further include, at 490, attaching a plurality of mechanical fasteners to the top cover bracket at the plurality of mechanical fastener apertures. As explained above, the mechanical fasteners 330 may pass through the mechanical fastener aperture 332 to couple the top cover bracket to the plurality of side panels 108, 110.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A washing machine appliance, defining a mutually orthogonal vertical direction, lateral direction, and transverse direction, the washing machine appliance comprising:
a cabinet assembly defining a cabinet aperture, the cabinet assembly comprising:
a plurality of spring support brackets permanently fastened to a top of a rear panel and a top of a plurality of side panels; and
a top cover bracket mechanically coupled to a top of the plurality of spring support brackets, the top cover bracket comprising:
a plurality of transverse locating tabs located on each of a plurality of ends of the top cover bracket; and
a lateral locating tab located on an end of the top cover bracket; and
a wash tub suspended within the cabinet assembly by a suspension assembly.

2. The washing machine appliance of claim 1, the cabinet assembly further comprises:
a rear panel;
a plurality of side panels coupled to the rear panel; and
a bottom panel coupled to the rear panel and plurality of side panels.

3. The washing machine appliance of claim 2, wherein the top cover bracket is mechanically coupled to a top of the plurality of side panels.

4. The washing machine appliance of claim 3, wherein each of the tops of the plurality of side panels comprises:
a plurality of mating slots configured to receive the plurality of transverse locating tabs and the lateral locating tab located on the top cover bracket.

5. The washing machine appliance of claim 4, wherein the plurality of transverse locating tabs are received in the plurality of mating slots to restrict top cover bracket translation in the transverse direction.

6. The washing machine appliance of claim 4, wherein the lateral locating tab is received in one of the plurality of mating slots to restrict top cover bracket translation in the lateral direction.

7. The washing machine appliance of claim 1, wherein each of the tops of the plurality of spring support brackets comprises:
a plurality of mating slots configured to receive a plurality of transverse locating tabs and a lateral locating tab located on the top cover bracket.

8. The washing machine appliance of claim 7, wherein the plurality of mating slots are configured to receive at least one of the plurality of transverse locating tabs and a lateral locating tab from the end of the top cover bracket.

9. The washing machine appliance of claim 1, the top cover bracket further comprises:
a mechanical fastener aperture located below each of the plurality of transverse locating tabs configured to receive a mechanical fastener.

10. The washing machine appliance of claim 1, wherein an end of the top cover bracket without a lateral locating tab comprises:
a mating slot cover plate.

11. A method of assembling a washing machine appliance, the washing machine appliance comprising a cabinet assembly defining a cabinet aperture, the cabinet assembly comprising a top cover bracket mechanically coupled to a top of a plurality of spring support brackets, the top cover bracket comprising a plurality of transverse locating tabs located on each of a plurality of ends of the top cover bracket, and a lateral locating tab located on an end of the top cover bracket, a plurality of spring support brackets, the spring support brackets comprising a plurality of mating slots configured to receive the plurality of transverse locating tabs and the lateral locating tab permanently fastened to a top of a rear panel and a top of a plurality of side panels, and a wash tub suspended within the cabinet assembly by a suspension assembly; the method comprising:
selecting a top cover bracket;
placing the top cover bracket on top of the cabinet assembly;
positioning the top cover bracket such that the plurality of transverse locating tabs are received in the plurality of mating slots in a plurality of tops of the plurality of spring support brackets to restrict top cover bracket translation in a transverse direction; and
positioning the top cover bracket such that the lateral locating tab is received in one of the plurality of mating slots in the plurality of tops of the plurality of spring support brackets to restrict top cover bracket translation in a lateral direction.

12. The method of claim 11, the method further comprising:
mechanically coupling the top cover bracket to a top of a plurality of spring support brackets via a plurality of mechanical fasteners.

13. The method of claim 11, the method further comprising:
mechanically coupling the top cover bracket to the top of a plurality of side panels via a plurality of mechanical fasteners.

14. The method of claim 11, wherein the cabinet assembly further comprises:
a rear panel;
a plurality of side panels coupled to the rear panel; and
a bottom panel coupled to the rear panel and plurality of side panels.

15. The method of claim 14, the plurality of side panels comprising:
a plurality of mating slots configured to receive the plurality of transverse locating tabs and the lateral locating tab permanently fastened to a top of a rear panel and a top of a plurality of side panels.

16. The method of claim 15, the method further comprising:
positioning the top cover bracket such that the plurality of transverse locating tabs are received in the plurality of mating slots in a plurality of tops of the plurality of side panels to restrict top cover bracket translation in the transverse direction; and
positioning the top cover bracket such that the lateral locating tab is received in one of the plurality of mating slots in the plurality of tops of the plurality of side panels to restrict top cover bracket translation in the lateral direction.

17. The method of claim 11, coupled is defined by permanently fastening a plurality of components together via a clinching technique.

18. The method of claim 11, wherein the end of the top cover bracket is defined by a right end of the top cover bracket.

19. The method of claim 11, wherein the end of the top cover bracket is defined by a left end of the top cover bracket.

20. The method of claim 11, wherein the top cover bracket further comprises a plurality of mechanical fastener apertures located below the plurality of transverse locating tabs, the method further comprising:
attaching a plurality of mechanical fasteners to the top cover bracket at the plurality of mechanical fastener apertures.
